(19) United States
(12) Patent Application Publication
(10) Pub. No.: US 2018/0189907 A1
(43) Pub. Date: Jul. 5, 2018

(54) SYSTEMS, APPARATUS, AND METHODS FOR MANAGING STAND-IN ATTORNEY APPEARANCES

(71) Applicant: Ejournment Inc., Brooklyn, NY (US)

(72) Inventor: Israel Solomon Fried, Brooklyn, NY (US)

(73) Assignee: Ejournment Inc., Brooklyn, NY (US)

(21) Appl. No.: 15/398,277

(22) Filed: Jan. 4, 2017

(51) Int. Cl. G06Q 50/18; G06Q 30/02; G06Q 10/10; G06Q 20/10

(52) U.S. Cl. CPC G06Q 50/18; G06Q 20/102; G06Q 10/1095; G06Q 30/0283

(57) ABSTRACT

Disclosed are systems, apparatus, and methods managing stand-in attorney appearances. An exemplary method includes receiving data regarding a court appearance from a user device, determining, based on the data, whether a stand-in attorney is available to cover the court appearance, determining a cost for the stand-in attorney court appearance, assigning a stand-in attorney to cover the court appearance, determining whether all necessary information regarding the court appearance has been received, receiving information from a stand-in attorney device regarding the court appearance, and providing a notification regarding the court appearance to the user device based on the information received from the stand-in attorney device.

### BACKGROUND

### Technical Field

The present disclosure relates to the management of stand-in attorney appearances, and more particularly, to systems, apparatus, and methods for operating a service for assigning stand-in attorneys to court appearances wherein an attorney responsible for the case is unable to appear.

### Description of Related Art

Criminal defense attorneys are called to appear in various routine court proceedings, including arraignments, conversion hearings, discovery hearings, status conferences, etc., throughout the life of a case. Such routine court proceedings often receive less than five minutes before the presiding judge, but, due to the manner in which court calendars are managed, could require the attorneys to wait for hours before their case is called before the court. Such extensive waiting times are an extremely inefficient use of the attorneys' time. Further, court proceedings are often scheduled without regard for the attorneys' calendar, and court proceedings in different cases handled by the same attorney could require an attorney to be in multiple courtrooms at the same time. Systems, apparatus, and methods for managing stand-in attorney appearances to assist attorneys with the above-described problems are described hereinbelow.

### SUMMARY

Provided in accordance with the present disclosure is a method of managing stand-in attorney appearances. According to an aspect of the present disclosure, the method includes receiving data regarding a court appearance from a user device, determining, based on the data, whether a stand-in attorney is available to cover the court appearance, determining a cost for the stand-in attorney court appearance, assigning a stand-in attorney to cover the court appearance, determining whether all necessary information regarding the court appearance has been received, receiving information from a stand-in attorney device regarding the court appearance, and providing a notification regarding the court appearance to the user device based on the information received from the stand-in attorney device.

In another aspect of the present disclosure, the data regarding the court appearance includes one or more of data regarding a type of the court appearance, data regarding a location of the court appearance, data regarding a time of the court appearance, and data regarding a case involved in the court appearance.

In yet another aspect of the present disclosure, the data regarding the type of court appearance includes at least one of an arraignment, a conversion hearing, a discovery hearing, a pre-trial readiness hearing, and a post-plea compliance hearing.

In still another aspect of the present disclosure, the data regarding the location of the court appearance includes at least one of a court wherein the court appearance is scheduled, a county in which the court wherein the court appearance is scheduled is located, and a part of the court wherein the court appearance is scheduled.

In a further aspect of the present disclosure, the data regarding the case involved in the court appearance includes at least one of, a case number of the case involved in the court appearance, a name of a party involved in the case, facts regarding the case, and a date for which the stand-in attorney should request an adjournment of the case.

In another aspect of the present disclosure, the cost of the stand-in attorney court appearance is determined based on the one or more of the type, location, and time of the court appearance.

In yet another aspect of the present disclosure, the method further includes determining, prior to assigning a stand-in attorney to the court appearance, whether the determined payment has been received, and providing a notification when it is determined that payment has not been received.

In still another aspect of the present disclosure, the method further includes providing a notification when it is determined that all necessary information regarding the court appearance has not been received.

In a further aspect of the present disclosure, the determination whether all necessary information regarding the court appearance has been received is based on a review of the information by the stand-in attorney assigned to the court appearance.

In another aspect of the present disclosure, the information regarding the court appearance received from the stand-in attorney device includes at least one of a status of the court appearance, a result of the court appearance, a date to which the case has been adjourned, and comments from the stand-in attorney regarding the court appearance.

In yet another aspect of the present disclosure, the method further includes determining whether a stand-in attorney is necessary for further court appearances in the case.

Provided in accordance with the present disclosure is a system for managing stand-in attorney appearances. According to an aspect of the present disclosure, the system includes a user device, a server, and a stand-in attorney device, the user device being configured to transmit data regarding a court appearance to the server, the server being configured to receive the data regarding the court appearance from the user device, determine, based on the data, whether a stand-in attorney is available to cover the court appearance, determine a cost for the stand-in attorney to cover the court appearance, assign a stand-in attorney to cover the court appearance, determine whether all necessary information regarding the court appearance has been received, receive information from a stand-in attorney device regarding the court appearance, and provide a notification regarding the court appearance to the user device based on the information received from the stand-in attorney device, and the stand-in attorney device being configured to transmit the information regarding the court appearance to the server.

Provided in accordance with the present disclosure is a non-transitory computer-readable storage medium storing instructions which, when executed by a processor, cause a computing device to receive data regarding a court appearance from a user device, determine, based on the data, whether a stand-in attorney is available to cover the court appearance, determine a cost for the stand-in attorney court appearance, assign a stand-in attorney to cover the court appearance, determine whether all necessary information regarding the court appearance has been received, receive information from a stand-in attorney device regarding the court appearance, and provide a notification regarding the court appearance to the user device based on the information received from the stand-in attorney device.

In another aspect of the present disclosure, the data regarding the court appearance includes one or more of data regarding a type of the court appearance, data regarding a location of the court appearance, data regarding a time of the court appearance, and data regarding a case involved in the court appearance.

In yet another aspect of the present disclosure, the data regarding the type of court appearance includes at least one of an arraignment, a conversion hearing, a discovery hearing, a pre-trial readiness hearing, and a post-plea compliance hearing.

In still another aspect of the present disclosure, the data regarding the location of the court appearance includes at least one of a court wherein the court appearance is scheduled, a county in which the court wherein the court appearance is scheduled is located, and a part of the court wherein the court appearance is scheduled.

In a further aspect of the present disclosure, the data regarding the case involved in the court appearance includes at least one of a case number of the case involved in the court appearance, a name of a party involved in the case, facts regarding the case, and a date for which the stand-in attorney should request an adjournment of the case.

In another aspect of the present disclosure, the cost of the stand-in attorney court appearance is determined based on the one or more of the type, location, and time of the court appearance.

In yet another aspect of the present disclosure, the instructions further cause the computing device to determine, prior to assigning a stand-in attorney to the court appearance, whether the determined payment has been received, and provide a notification when it is determined that payment has not been received.

In still another aspect of the present disclosure, the instructions further cause the computing device to provide a notification when it is determined that all necessary information regarding the court appearance has not been received.

Any of the above aspects and embodiments of the present disclosure may be combined without departing from the scope of the present disclosure.

### BRIEF DESCRIPTION OF THE DRAWINGS

Various aspects and features of the present disclosure are described hereinbelow with references to the drawings, wherein:

FIG. 1 shows a schematic diagram of a system for managing stand-in attorney appearances, according to an embodiment of the present disclosure;

FIG. 2A shows a simplified block diagram of an example computing device forming part of the system of FIG. 1, according to an embodiment of the present disclosure;

FIG. 2B shows a simplified block diagram of an example server forming part of the system of FIG. 1, according to an embodiment of the present disclosure;

FIG. 3 shows a flowchart of an example method for operating a server as part of a service for managing stand-in attorney appearances, according to an embodiment of the present disclosure;

FIG. 4 shows an exemplary graphical user interface which may be displayed by one or more computing devices forming part of the system of FIG. 1, according to an embodiment of the present disclosure;

FIG. 5 shows another exemplary graphical user interface which may be displayed by one or more computing devices forming part of the system of FIG. 1, according to an embodiment of the present disclosure;

FIG. 6 shows another exemplary graphical user interface which may be displayed by one or more computing devices forming part of the system of FIG. 1, according to an embodiment of the present disclosure;

FIG. 7 shows another exemplary graphical user interface which may be displayed by one or more computing devices forming part of the system of FIG. 1, according to an embodiment of the present disclosure;

FIG. 8 shows another exemplary graphical user interface which may be displayed by one or more computing devices forming part of the system of FIG. 1, according to an embodiment of the present disclosure;

FIG. 9 shows another exemplary graphical user interface which may be displayed by one or more computing devices forming part of the system of FIG. 1, according to an embodiment of the present disclosure; and

FIG. 10 shows another exemplary graphical user interface which may be displayed by one or more computing devices forming part of the system of FIG. 1, according to an embodiment of the present disclosure.

### DETAILED DESCRIPTION

The present disclosure is directed to systems, apparatus, and methods for managing stand-in attorney appearances. More particularly, the present disclosure relates to operating a service for managing stand-in attorney appearances. As described above, attorneys are required to appear in routine court proceedings on an almost daily basis, often in different courtrooms (and even different court facilities scattered over the geographic area of their practice) on the same day and even at the same time, and are then required to wait for their case to be called before the court, which could cause them to wait for hours in a courtroom for a proceeding often lasting mere minutes before being adjourned to a later date. While larger firms may coordinate to cover appearances where a particular attorney is unavailable to appear in a routine court proceeding for a case for which the particular attorney is responsible, smaller firms and/or solo practitioners may not have resources available to provide such coverage. As described herein, a service that collects information necessary for a stand-in attorney to cover an appearance in a routine court proceeding, and assigns available attorneys who have signed up to provide coverage for such appearances in routine court proceedings on a per diem basis, may provide coverage to small firms and solo practitioners who are unavailable to appear in routine court proceedings for cases for which they are responsible.

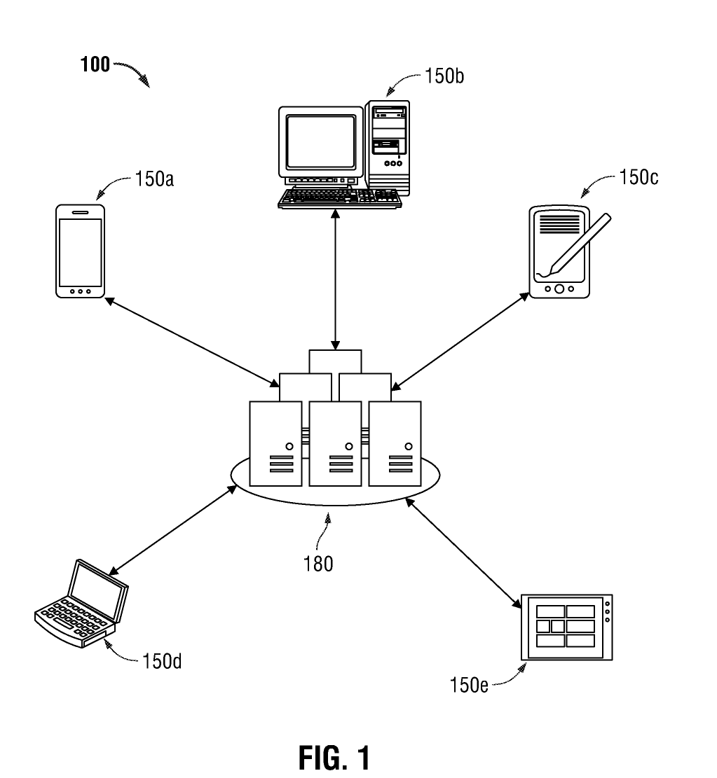

With reference to FIG. 1, there is shown a schematic diagram of a system 100 for managing stand-in attorney appearances, according to an embodiment of the present disclosure. System 100 may include a plurality of computing devices 150, such as smart phones 150a, desktop computers 150b, personal digital assistants (PDAs) 150c, laptop computers 150d, and/or tablet computers 150e, all connected to a server 180. Server 180 may be a single server, an array of servers, and/or a cloud-based server system. The plurality of computing devices 150a, 150b, 150c, 150d, and 150e are referred to collectively hereinafter simply as computing device 150.

Computing device 150 is connected to server 180 via a network, such as the internet (although those skilled in the art will appreciate that any suitable network may be substituted for the internet in the examples described hereinbelow). Computing device 150 may be used by a user, such as a responsible attorney (that is, an attorney who is responsible for a particular case), and/or by a stand-in attorney (that is, an attorney who is not the responsible attorney for a particular case, but may be assigned on a per diem basis to cover an appearance in the particular case on behalf of the responsible attorney). Thus, responsible attorneys and stand-in attorneys may interact with server 180 via computing device 150 over a network.

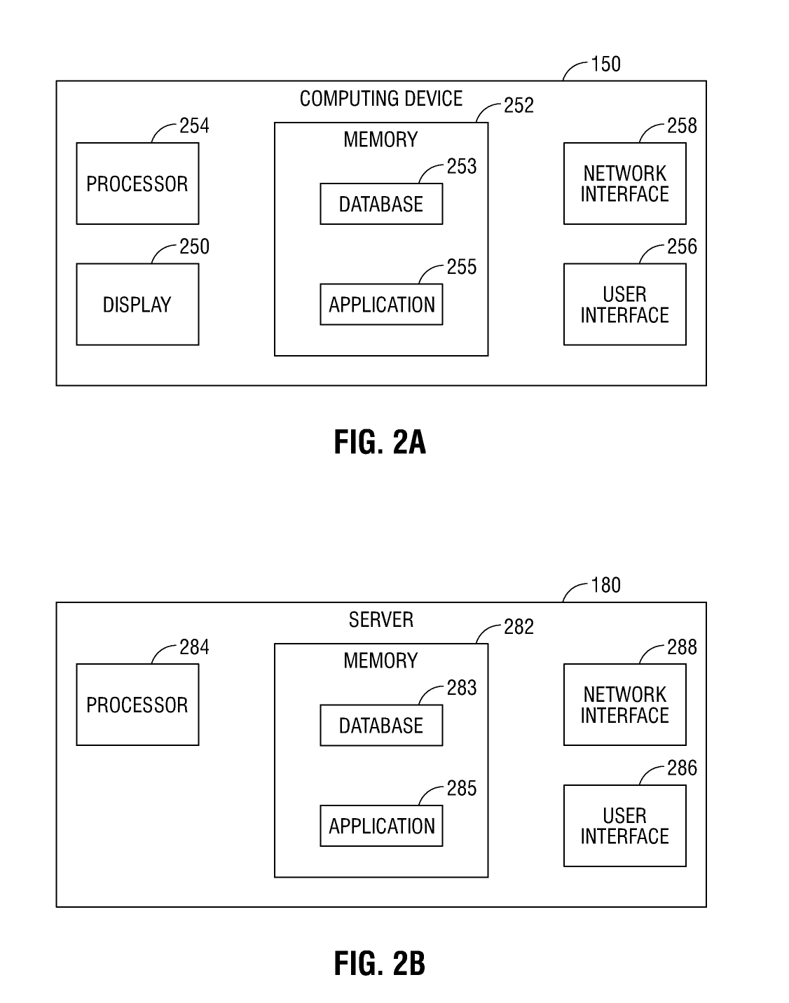

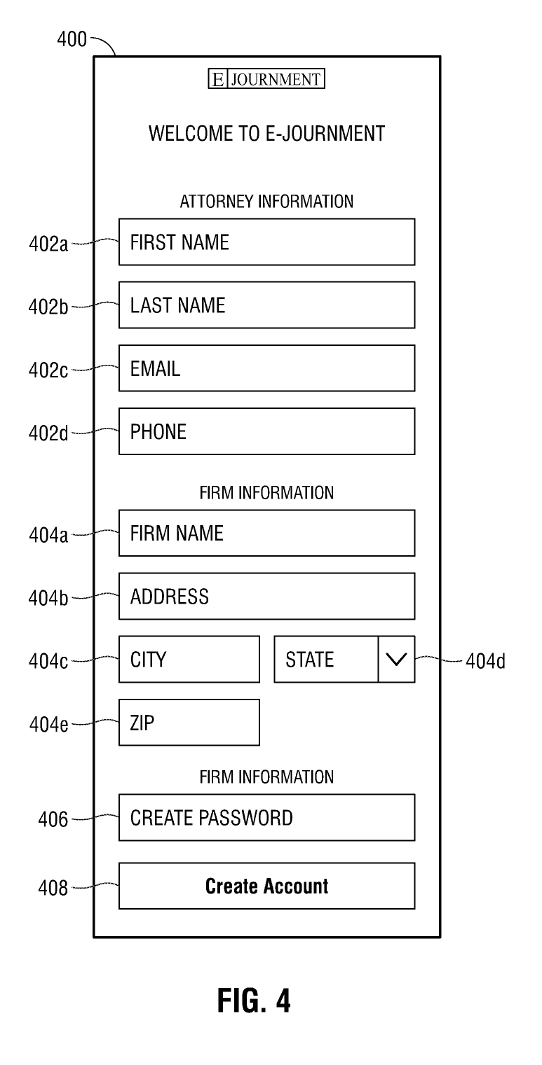

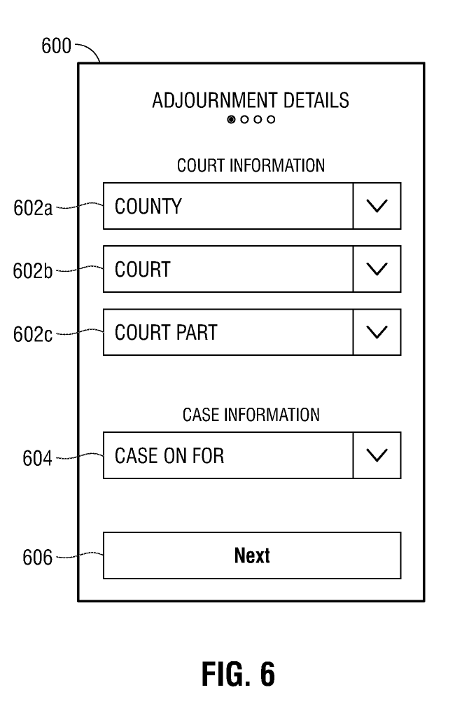

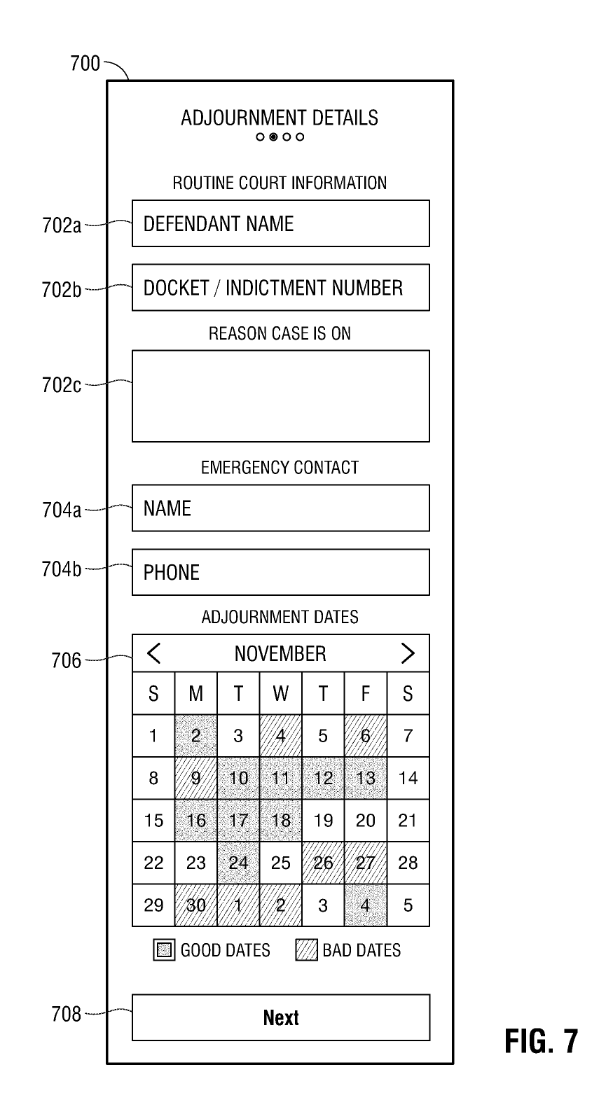

With reference to FIG. 2A, there is shown simplified block diagram of computing device 150. Computing device 150 may include at least one memory 252, one or more processors 254, a display 250, a network interface 258, and one or more user interfaces 256. Memory 252 may store a database 253 and an application 255. Application 255 may, when executed by processor 254, cause display 250 to output a graphical user interface (GUI), such as described below with reference to FIGS. 4-11.

Memory 252 may include any non-transitory computer-readable storage media for storing data and/or software that is executable by processor 254 and which controls the operation of computing device 150. In an embodiment, memory 252 may include one or more solid-state storage devices such as flash memory chips. Alternatively, or in addition to the one or more solid-state storage devices, memory 252 may include one or more mass storage devices connected to processor 254 through a mass storage controller (not shown) and a communications bus (not shown). Although the description of computer-readable media contained herein refers to a solid-state storage, it should be appreciated by those skilled in the art that computer-readable storage media can be any available media that can be accessed by processor 254. That is, computer-readable storage media includes non-transitory, volatile and non-volatile, removable and non-removable media implemented in any method or technology for storage of information such as computer-readable instructions, data structures, program modules, or other data. For example, computer-readable storage media may include RAM, ROM, EPROM, EEPROM, flash memory or other solid-state memory technology, CD-ROM, DVD, Blu-Ray or other optical storage, magnetic cassettes, magnetic tape, magnetic disk storage or other magnetic storage devices, or any other medium which can be used to store the desired information and which can be accessed by computing device 150.

Network interface 258 may be configured to connect to a network such as a local area network (LAN) consisting of a wired network and/or a wireless network, a wide area network (WAN), a wireless mobile network, a Bluetooth network, and/or the internet. User interface 256 may be any apparatus or component by means of which a user may interact with computing device 150, such as, for example, a mouse, keyboard, touch pad, touch screen, voice interface, computer vision interface, and/or any other device or interface usable to interact with a computing device known to those skilled in the art.

With reference to FIG. 2B, server 180, similar to computing device 150 described above, may include at least one memory 282, one or more processors 284, a network interface 288, and one or more user interfaces 286. Memory 252 may store a database 283 and an application 285. The components of server 180 may be similar in function to the above-described components of computing device 150, and therefore will not be described again.

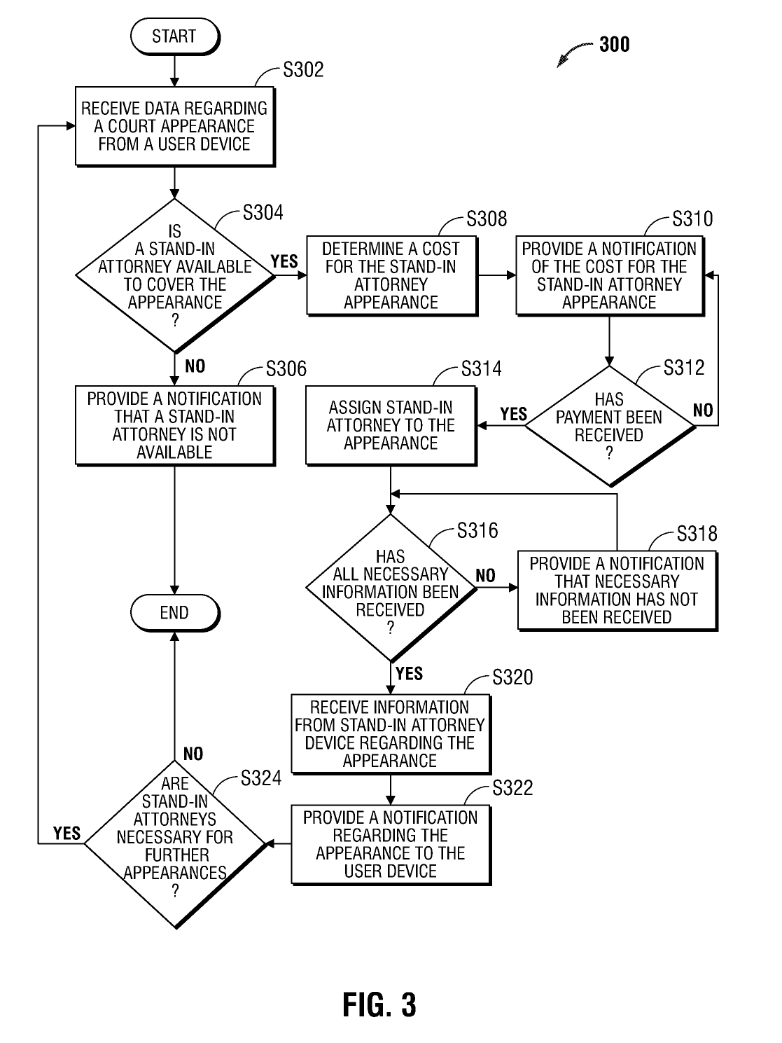

Turning now to FIG. 3, there is shown a flowchart of an exemplary method 300 for managing stand-in attorney appearances, according to an embodiment of the present disclosure. Method 300 may be performed using the systems and apparatus described above with reference to FIGS. 1, 2A, and/or 2B. Method 300 is described below with reference to a sequence of steps and operations performed by one or more devices. However, the provided sequence and order of operations is merely for illustrative purposes and the disclosure is not intended to be limited to the provided sequence or order of operations. Further, those skilled in the art will recognize that the described steps and operations may be performed in a different order, and/or omitted entirely, without departing from the scope of the present disclosure.

As noted above, a responsible attorney may be scheduled to appear in a routine court appearance for a case. The responsible attorney may, at some point in time after the routine court appearance is scheduled, determine that the responsible attorney is unable to be present for the routine court appearance. The responsible attorney may then seek to have a stand-in attorney appear in the routine court appearance on behalf of the responsible attorney. In the example described below, the responsible attorney uses an application, such as application 255, to enter data regarding the court appearance into computing device 150. Thus, starting at step S302, server 180 receives the data regarding the court appearance from computing device 150.

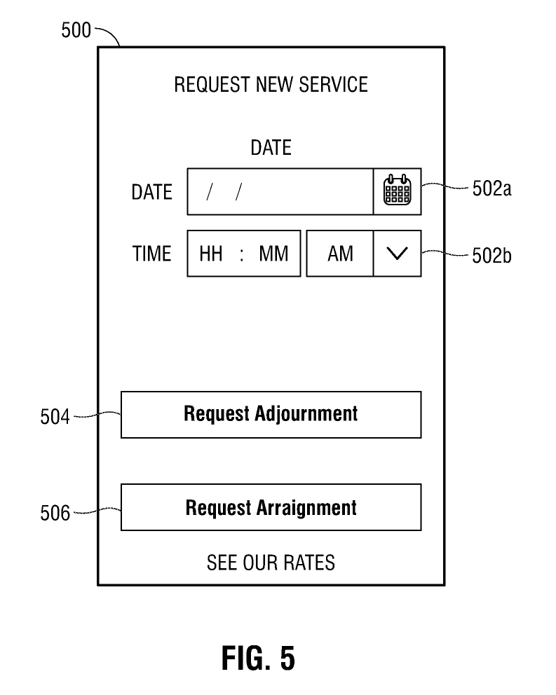

As shown in FIGS. 5-7 (described below), the data regarding the court appearance may include a date of the court appearance, a time of the court appearance, a type of the court appearance, a location of the court appearance, and/or other data regarding the case involved in the court appearance. For example, the date of the court appearance may indicate that the court appearance is scheduled for a weekend or holiday (arraignment hearings have to occur within a matter of hours after a defendant is arrested, and thus may be scheduled for any day of the year). Similarly, the time of the court appearance may indicate that the court appearance is scheduled outside of regular business hours. The type of the court appearance may indicate whether the court appearance is an arraignment, conversion hearing, discovery hearing, status conference such as a pre-trial readiness hearing or a post-plea compliance hearing, and/or any other type of routine court appearance, and may further indicate whether the court appearance is to take place in a specialized court, such as a drug court, a youth court, a veterans court, etc. Further, the location of the court appearance may indicate a particular court (such as supreme court, criminal court, town court, county court, village court, traffic court, etc.) wherein the court appearance is scheduled, a county, town, or other geographic area in which the court wherein the court appearance is scheduled is located, and a part of the court wherein the court appearance is scheduled. The other data regarding the case involved in the court appearance may include a case, docket, or indictment number, a name of a party or defendant, facts or other information pertinent to the case, and/or a date or number of dates for which the stand-in attorney should request an adjournment of the case. For example, the responsible attorney may provide the stand-in attorney with a number of good dates and bad dates for which to request an adjournment.

Application 285, executing on server 180, then determines, at step 5304, whether a stand-in attorney is available to cover the court appearance on behalf of the responsible attorney. For example, application 285 may maintain a database of potential stand-in attorneys, their availability, as well as other data regarding the stand-in attorneys including their skill and/or experience level, geographic location, ranking based on previous assignments, and reliability. The reliability of a stand-in attorney may be based on, for example, the number of assignments a stand-in attorney accepts compared to the number assigned to the stand-in attorney. If more than one stand-in attorney is available to cover the court appearance, application 285 may select one of the stand-in attorneys based on the other data regarding the stand-in attorneys. For example, application 285 may select the stand-in attorney with the most skill and/or experience with a particular type of court appearance. Application 285 may also select the stand-in attorney based on one or more preferences selected by the responsible attorney.

If application 285 determines that a stand-in attorney is not available to cover the court appearance, application 285 may, at step S306, provide a notification that a stand-in attorney is not available to cover the court appearance. The notification may be sent to computing device 150 used by the responsible attorney, and computing device 150 may in turn display or otherwise provide the responsible attorney with the notification.

Alternatively, if application 285 determines that a stand-in attorney is available to cover the court appearance, application 285 may, at step S308, determine a cost for the stand-in attorney to cover the court appearance. The cost may be based on the particular type of court appearance, stand-in attorney's skill and/or experience level with the particular type of court appearance, the time of the court appearance, etc. For example, a court appearance scheduled for a weekend, holiday, or overnight hours may have a higher cost than a court appearance scheduled during regular business hours. Additionally, a specialized type of court appearance may have a higher cost than a more routine court appearance. Application 285 may then, at step S310, send data and/or a notification to computing device 150 to inform the responsible attorney of the cost for the stand-in attorney to cover the court appearance, and provide a request that the responsible attorney provide payment for the cost. Thereafter, at step S312, application 285 determines whether payment of the cost of the stand-in attorney to cover the court appearance has been received. If, after a pre-determined period of time, for example a day or any other period of time applicable to the particular court appearance, application determines that payment has not been received, processing may return to step S310 and application 285 may provide another request that the responsible attorney provide payment for the cost.

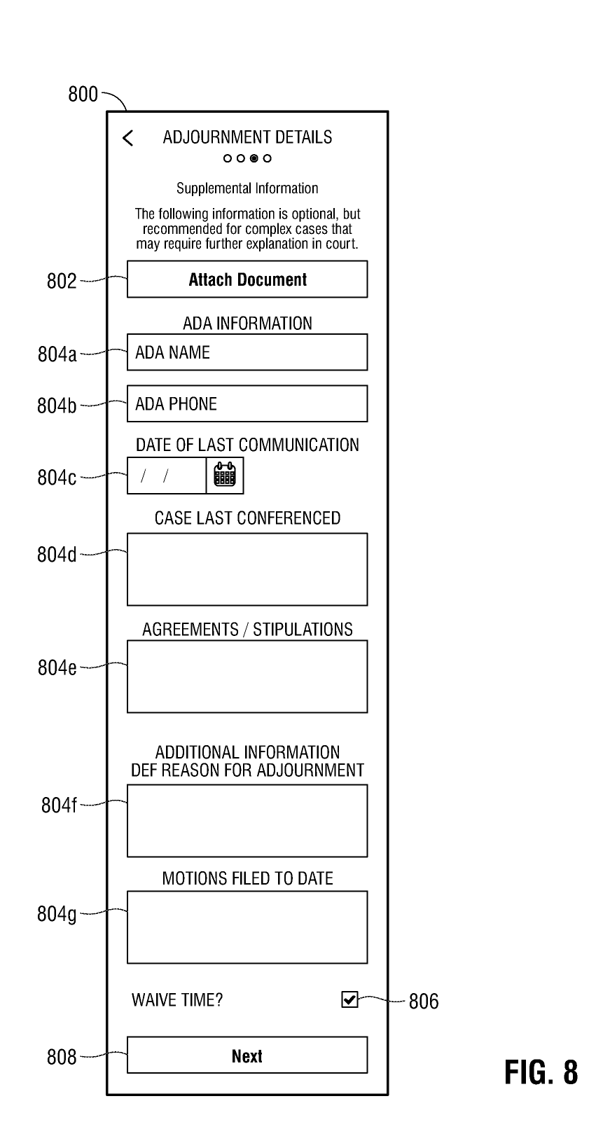

Once application 285 determines that payment for the cost has been received, processing proceeds to step S314, where application 285 assigns a stand-in attorney to cover the court appearance. For example, application 285 may send a notification to a computing device 150 used by the stand-in attorney to inform the stand-in attorney of the court appearance and provide the stand-in attorney with the data regarding the court appearance received from the responsible attorney. In some embodiments, application 285 may determine prior to providing the stand-in attorney with the data regarding the court appearance, whether all necessary information regarding the court appearance has been received. In other embodiments, application 285 may simply provide the stand-in attorney with all the data regarding the court appearance received from the responsible attorney, and request that the stand-in attorney verify that all necessary information regarding the court appearance has been received. Thus, at step S316, application 285 determines, either automatically or based on input provided by the stand-in attorney, whether all necessary information has been received. For example, the necessary information may include at least a date, time, location, and type of the court appearance, as well as case identification information. However, depending on the type of court appearance, further information, as shown in FIG. 8 (described below) may also be necessary, such as a status of the case, and particular facts regarding the case, such as a name of the prosecuting attorney or other opposing counsel.

If application 285 determines that all necessary information has not been received, application 285 may, at step S318, send a notification to computing device 150 used by the responsible attorney to inform the responsible attorney that all necessary information regarding the court appearance has not been received. Alternatively, if application 285 determines that all necessary information regarding the court appearance has been received, application 285 awaits further information from the stand-in attorney regarding the court appearance. For example, the information from the stand-in attorney may include a date to which the case has been adjourned, details on what happened during the court appearance, information regarding instructions and/or orders from the judge, and/or other comments from the stand-in attorney.

Application 285 may receive, at step S320, the information from the stand-in attorney regarding the court appearance, and may, at step S322, provide a notification to computing device 150 to inform the responsible attorney of the information from the stand-in attorney. For example, the notification may inform the responsible attorney of the date to which the case was adjourned, and/or details on what happened during the court appearance.

Thereafter, at step S324, application 285 determines whether stand-in attorneys are necessary for further court appearances for the same case. For example, if application 285 determines that the date to which the case was adjourned is not one of the good dates provided by the responsible attorney at step S302, application 285 may provide a notification to computing device 150 used by the responsible attorney to enquire if a stand-in attorney will be necessary for the next scheduled court appearance.

If stand-in attorneys are necessary for further appearances for the same case, processing returns to step S302. Alternatively, if stand-in attorneys are not necessary for further appearances for the same case, processing ends.

Turning now to FIG. 4, there is shown an exemplary graphical user interface (GUI) 400 that may be displayed by application 255 when the responsible attorney first creates an account with the service operated by server 180. The responsible attorney may be requested to provide information regarding the responsible attorney including a first name 402a, a last name 402b, an email address 402c, and a phone number 402d. In addition, the responsible attorney may be requested to provide information regarding the responsible attorney's firm or office, including a firm name 404a, a firm street address 404b, city 404c, state 404d, and zip code 404e. The responsible attorney may also be requested to provide a password 406 for the account. After entering the requested information, the responsible attorney may create an account by selecting button 408.

Turning now to FIG. 5, there is shown another exemplary GUI 500 that may be displayed by application 255 when the responsible attorney requests a stand-in attorney to cover a court appearance. GUI 500 includes fields for the responsible attorney to enter a date 502a and a time 502b of the court appearance, as well as buttons to either request a stand in attorney to an adjournment proceeding 504 or an arraignment proceeding 506.

If the responsible attorney selects the adjournment button 504, application 255 may display another exemplary GUI 600 that provides fields for the responsible attorney to enter information regarding the court in which the appearance is scheduled, including fields for the county (or other geographic division) 602a, the court 602b, and the court part 602c. A field may also be provided for the type of court appearance 604 that is scheduled. After entering this information, the responsible attorney may select the next button 606 to send the information to server 180.

Thereafter, another exemplary GUI 700 may be displayed that provides fields for the responsible attorney to enter information regarding the case involved in the court appearance, including fields for a name of the defendant (or client) 702a, a docket, case, or indictment number 702b, and other information such as a reason why the appearance is scheduled 702c. Additional fields may be provided for emergency contact information in the event that the stand-in attorney must get in contact with the responsible attorney or another attorney managing the case, such as fields for an emergency contact name 704a and phone number 704b. A calendar 706 may also be provided by means of which the responsible attorney can indicate which are good dates and bad dates for which the stand-in attorney should request the adjournment. After providing this information, the responsible attorney may select the next button 708 to send the information to server 180.

Thereafter, another exemplary GUI 800 may be displayed that provides fields for the responsible attorney to enter optional additional information regarding the case involved in the court appearance, including a button 802 to attach documents related to the case, and fields for the prosecuting attorney or opposing counsel 804a, a phone number 804b for the prosecuting attorney or opposing counsel, a date 804c of the last communication regarding the case, as well as information regarding when the case was last conferenced 804d, any agreements or stipulations 804e that were agreed to, the defense's reason 804f for requesting the adjournment, and a list of any motions filed in the case 804g. A button 806 may also be provided to indicate if the stand-in attorney may agree to waive time, or object to requests for waiver of time. For example, if the defendant has already agreed, or given the responsible attorney permission to waive the defendant's right to a speedy trial, the responsible attorney may indicate to the stand-in attorney that time may be waived. After providing this information, the responsible attorney may select the next button 808 to send the information to server 180.

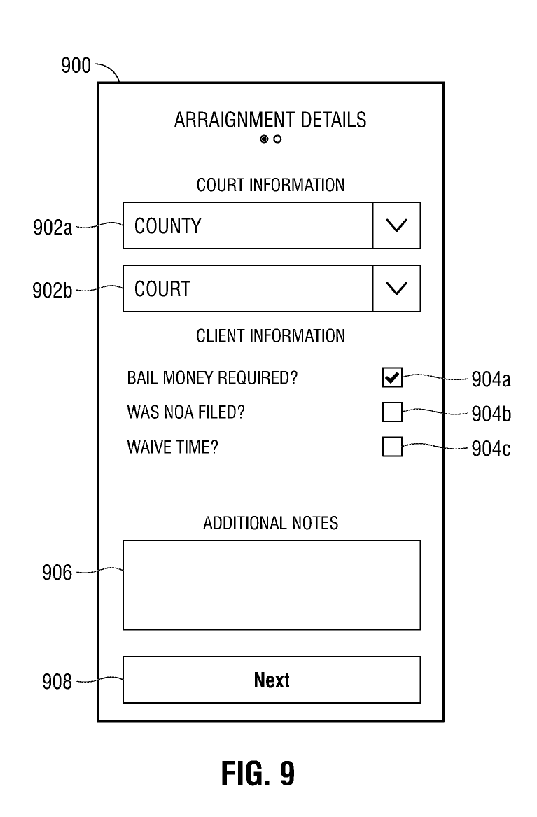

Referring now to FIG. 9, there is shown a GUI 900 which may be displayed by application 255 if the responsible attorney selects the arraignment button 504 (FIG. 5). GUI 900 provides fields for the responsible attorney to enter information regarding the court in which the appearance is scheduled, including fields for the county (or other geographic division) 902a, and the court 902b. Fields may also be included to provide an indication whether bail money is required 904a, whether a notice of appearance has been filed in the case 904b, and whether time has been waived 904c. Additionally, a field may be provided for the responsible attorney to enter additional notes 906 regarding the case. After entering this information, the responsible attorney may select the next button 908 to send the information to server 180.

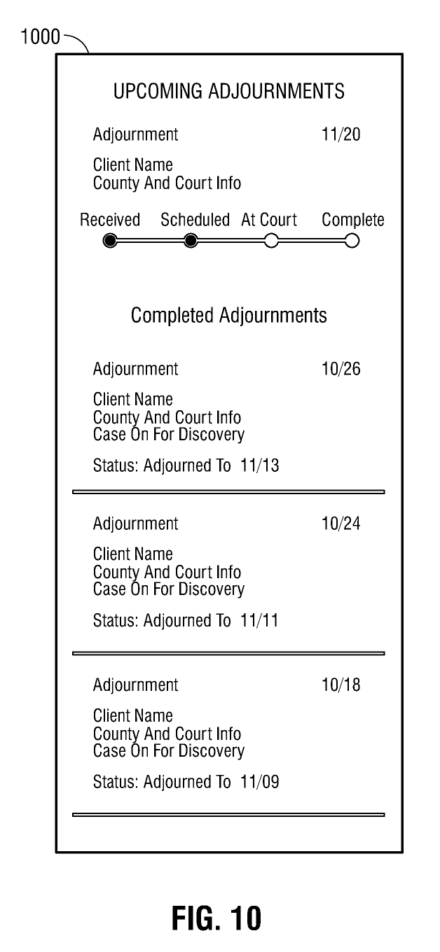

FIG. 10 shows a GUI 1000 which may be displayed by application 255 on a computing device 150 used by the stand-in attorney to show which court appearances the stand-in attorney has been assigned to.

Detailed embodiments of devices, systems incorporating such devices, and methods using the same as described herein. However, these detailed embodiments are merely examples of the disclosure, which may be embodied in various forms. Therefore, specific structural and functional details disclosed herein are not to be interpreted as limiting, but merely as a basis for the claims and as a representative basis for allowing one skilled in the art to variously employ the present disclosure in appropriately detailed structure.

What is claimed is:

1. A method for managing stand-in attorney appearances comprises:
receiving data regarding a court appearance from a user device;
determining, based on the data, whether a stand-in attorney is available to cover the court appearance;
determining a cost for the stand-in attorney court appearance;
assigning a stand-in attorney to cover the court appearance;
determining whether all necessary information regarding the court appearance has been received;
receiving information from a stand-in attorney device regarding the court appearance; and
providing a notification regarding the court appearance to the user device based on the information received from the stand-in attorney device.

2. The method according to claim 1, wherein the data regarding the court appearance includes one or more of:
data regarding a type of the court appearance;
data regarding a location of the court appearance;
data regarding a time of the court appearance; and
data regarding a case involved in the court appearance.

3. The method according to claim 2, wherein the data regarding the type of court appearance includes at least one of:
an arraignment;
a conversion hearing;
a discovery hearing;
a pre-trial readiness hearing; and
a post-plea compliance hearing.

4. The method according to claim 2, wherein the data regarding the location of the court appearance includes at least one of:
a court wherein the court appearance is scheduled;
a county in which the court wherein the court appearance is scheduled is located; and
a part of the court wherein the court appearance is scheduled.

5. The method according to claim 2, wherein the data regarding the case involved in the court appearance includes at least one of:
a case number of the case involved in the court appearance;
a name of a party involved in the case;
facts regarding the case; and
a date for which the stand-in attorney should request an adjournment of the case.

6. The method according to claim 2, wherein the cost of the stand-in attorney court appearance is determined based on the one or more of the type, location, and time of the court appearance.

7. The method according to claim 1, further comprising:
determining, prior to assigning a stand-in attorney to the court appearance, whether the determined payment has been received; and
providing a notification when it is determined that payment has not been received.

8. The method according to claim 1, further comprising providing a notification when it is determined that all necessary information regarding the court appearance has not been received.

9. The method according to claim 1, wherein the determination whether all necessary information regarding the court appearance has been received is based on a review of the information by the stand-in attorney assigned to the court appearance.

10. The method according to claim 1, wherein the information regarding the court appearance received from the stand-in attorney device includes at least one of:
a status of the court appearance;
a result of the court appearance;
a date to which the case has been adjourned; and
comments from the stand-in attorney regarding the court appearance.

11. The method according to claim 1, further comprising determining whether a stand-in attorney is necessary for further court appearances in the case.

12. A system for managing stand-in attorney appearances, the system comprising a user device, a server, and a stand-in attorney device, wherein:
the user device is configured to:
transmit data regarding a court appearance to the server;
the server is configured to:
receive the data regarding the court appearance from the user device;
determine, based on the data, whether a stand-in attorney is available to cover the court appearance;
determine a cost for the stand-in attorney to cover the court appearance;
assign a stand-in attorney to cover the court appearance;
determine whether all necessary information regarding the court appearance has been received;
receive information from a stand-in attorney device regarding the court appearance; and
provide a notification regarding the court appearance to the user device based on the information received from the stand-in attorney device; and
the stand-in attorney device is configured to transmit the information regarding the court appearance to the server.

13. A non-transitory computer-readable storage medium storing instructions which, when executed by a processor, cause a computing device to:
receive data regarding a court appearance from a user device;
determine, based on the data, whether a stand-in attorney is available to cover the court appearance;
determine a cost for the stand-in attorney court appearance;
assign a stand-in attorney to cover the court appearance;
determine whether all necessary information regarding the court appearance has been received;
receive information from a stand-in attorney device regarding the court appearance; and
provide a notification regarding the court appearance to the user device based on the information received from the stand-in attorney device.

14. The non-transitory computer-readable storage medium according to claim 13, wherein the data regarding the court appearance includes one or more of:
data regarding a type of the court appearance;
data regarding a location of the court appearance;
data regarding a time of the court appearance; and
data regarding a case involved in the court appearance.

15. The non-transitory computer-readable storage medium according to claim 14, wherein the data regarding the type of court appearance includes at least one of:
an arraignment;
a conversion hearing;
a discovery hearing;
a pre-trial readiness hearing; and
a post-plea compliance hearing.

16. The non-transitory computer-readable storage medium according to claim 14, wherein the data regarding the location of the court appearance includes at least one of:
a court wherein the court appearance is scheduled;
a county in which the court wherein the court appearance is scheduled is located; and
a part of the court wherein the court appearance is scheduled.

17. The non-transitory computer-readable storage medium according to claim 14, wherein the data regarding the case involved in the court appearance includes at least one of:
a case number of the case involved in the court appearance;
a name of a party involved in the case;
facts regarding the case; and
a date for which the stand-in attorney should request an adjournment of the case.

18. The non-transitory computer-readable storage medium according to claim 14, wherein the cost of the stand-in attorney court appearance is determined based on the one or more of the type, location, and time of the court appearance.

19. The non-transitory computer-readable storage medium according to claim 13, wherein the instructions further cause the computing device to:
determine, prior to assigning a stand-in attorney to the court appearance, whether the determined payment has been received; and
provide a notification when it is determined that payment has not been received.

20. The non-transitory computer-readable storage medium according to claim 13, wherein the instructions further cause the computing device to provide a notification when it is determined that all necessary information regarding the court appearance has not been received.
